(19) United States
(12) Patent Application Publication
(10) Pub. No.: US 2009/0084410 A1
(43) Pub. Date: Apr. 2, 2009

(54) DETACHING TRACES OF PARTICLES ADHERING TO AN OBJECT SURFACE AND COLLECTING THEM ONTO A PARTICLE COLLECTION AREA

(76) Inventors: Robert Roach, Ramat Hasharon (IL); Steven Shamash, Netanya (IL); Rafi Zchout, Givatayim (IL); Gil Perlberg, Zikron Yakov (IL); Yarden Tsach, Shimshit (IL); Roy Ornath, Tel Aviv (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/244,746

(22) Filed: Oct. 2, 2008

Related U.S. Application Data
(60) Provisional application No. 60/960,508, filed on Oct. 2, 2007.

(51) Int. Cl. B08B 5/00; H01J 49/40; G01N 30/02; G01J 3/28; A47L 5/14

(52) U.S. Cl. 134/21; 250/286; 73/23.35; 356/326; 15/345

(57) ABSTRACT

A system for inspecting wearable people footwear, comprising:
a person's standing grille, an air stream chamber, whereas the grille is one of the partitions of the chamber, a plurality of blowing jets surrounding the object and a vacuum port.

While said object is being under normal atmospheric conditions, the particles are being detached from the object exterior surface by said plurality of blowing jets detached particles are passing through said grille holes and are carried by near surface airfoil streams generated within the chamber and directed towards the vacuum port. An analyzer instrument analyzes the particles, collected at the particle collection area.

### FIELD OF THE INVENTION

The present invention generally relates to inspection systems usable for detecting existence of sought for materials by analyzing traces of particles adhered to the exterior surface of objects.

The present invention particularly relates to an airport security system used for inspecting footwear for sought-for materials by analyzing particles adhered to the footwear while it is being worn.

### BACKGROUND OF THE INVENTION

Several incidents of terrorist acts in recent years directed at airline carriers, brought security agencies to realize the vulnerability of air transportation and air travel to terrorist attacks. Terrorist groups realize this vulnerability and are targeting air travel for deadly attacks. Air travel is also the most common means used for smuggling hazardous materials across countries and continents. Hence aviation agencies of most nations are willing to apply any required measures to secure their air travel and air transportation industries from terrorist attacks and from smuggling of hazardous materials, regardless of the associated price tag and the inconveniences inflicted on the air travelers. Security measures include screening checked in and hand carried luggage by metal detectors and explosive and hazardous materials detection systems. Security checkpoints are located in airports to ensure that terrorists can not bring anything aboard a plane that would enable them to take it over or destroy it. These are called “prohibited items” and cannot be brought to a checkpoint, into the secure area of an airport, or aboard an aircraft.

The Federal Transportation Security Administration (TSA) originally began a program of randomly selecting air travelers to remove their footwear and place them on a conveyor carrying other objects to detecting systems, for security screening. The program expanded to the present to where every passenger removes footwear during the security check.

TSA's increased focus on screening footwear in the past few years reflects a necessary reaction to information gathered by federal intelligence agencies. Consequently TSA has been moving to make sure its footwear policy is implemented consistently from coast to coast and screeners have been given explicit guidance on which footwear requires X-ray screening. Complaints from air travelers about the inconvenience caused by removing and putting footwear back on, along with the associated health hazard caused a large number of persons stepping barefoot on the floor have prompted the TSA to begin inspecting air travelers without having them to take their shoes off, hence avoiding the inconvenience, the health hazards, the delays and conducting the inspections at faster rate and higher reliability. But this comes at the cost of higher security risk.

Commercially available metal detectors effortlessly detect metals in footwear while worn. However, these detectors cannot be used for explosive trace inspection. Hence there is still a need for a system which can inspect quickly and reliably traces of sought for materials on people's footwear without having to remove it.

### SUMMARY OF THE INVENTION

It is the object of the present invention to disclose a system usable for detaching particles which adhere to the exterior surface of an object, and carrying said particles to a particle collection area, comprising: an object placement grille, an air stream chamber wherein the grille is one of the partitions of the chamber, a plurality of blowing jets, jets surrounding said object, and a vacuum port. wherein while said object is being under normal atmospheric conditions, said particles are being detached from said object exterior surface by said plurality of blowing jets; said detached particles are passing through said grille and are carried by near surface airstreams generated within said chamber and directed towards said vacuum port to the collection area

Another object of the present invention and any of the above is to disclose a system, wherein said near surface airstream, brings about that particles do not stick to said inside chamber surfaces and consequently a substantial portion said particles reach said particle collection area.

Another object of the present invention and any of the above is to disclose a system, wherein a particle analyzer analyzes said particles reaching said collection area.

Another object of the present invention and any of the above is to disclose a system that further comprises a vacuum and compression units.

Another object of the present invention and any of the above is to disclose a system that further comprises a control system controlling various system assemblies.

Another object of the present invention and any of the above is to disclose a system, wherein said control system further comprises an application programming interface and an interface to external systems.

It is the object of the present invention to disclose a system comprising: a grille on which worn footwear is placed, an air stream chamber; wherein said grille is one of the partitions of said chamber with a plurality of blowing jets. The jets are surrounding said object and a vacuum port wherein while said object is being under normal atmospheric conditions, the particles are being detached from said object exterior surface by said plurality of blowing jets; said detached particles are passing through said grille holes and are carried by near surface airfoil streams generated within said chamber and directed towards said vacuum port.

Another object of the present invention is to disclose a system, wherein a particle analyzer analyzes said particles reaching said collection area.

Another object of the present invention is to disclose that said analyzer is an instrument selected from a list consisting of: Ion Mobility Spectroscopy (IMS), gas chromatography, laser induced spectroscopy or any combination there of.

Another object of the present invention and any of the above is to disclose a system, further comprising a vacuum and compression unit.

Another object of the present invention and any of the above is to disclose a system, wherein said system is adapted for effortlessly getting on the system and getting off the system.

Another object of the present invention is to disclose a system wherein collected particles reaching said particle collection area are adhering to a filter disposed at said particle collection area.

Another object of the present invention and any of the above is to disclose a system wherein a batch of a plurality of filters is configured and an individual filter of the batch is selected each time automatically.

Another object of the present comprises accommodating high humidity atmospheric conditions.

Another object of the present invention and any of the above is to disclose a system of particles prior to detecting and analyzing said particles.

Another object of the present invention and any of the above is to disclose a system, another invention adaptable to any size and shape of footwear.

It is the object of the present invention to disclose a method for detaching particles adhering to the exterior surface of an object, comprising: obtaining a system comprising: an object placement grille, an air stream chamber, whereas the grille is one of the partitions of said chamber, a plurality of blowing jets surrounding said object and a vacuum port. placing an object onto the system object placement grille, and detaching the particles from said object surface wherein while said object is being under normal atmospheric conditions, detaching the particles from said object exterior surface is carried out by said plurality of blowing jets and passing the detached particles through said grille holes and are carried by near surface air streams generated within said chamber and directed towards said vacuum port.

Another object of the present invention and any of the above is to disclose a method that further comprises detecting and analyzing the particles by a particle analyzer.

### BRIEF DESCRIPTION OF THE DRAWING AND FIGURES

In order to understand the invention and to see how it may be implemented in practice, a plurality of preferred embodiments will now be described, by way of non-limiting example only, with reference to the accompanying drawing, in which

FIG. 1 illustrates a non-dimensionally scaled schematic block diagram of the particle trace inspection system according to an embodiment of the present invention;

FIG. 2 illustrates a non-dimensionally scaled cross sectional view of a subsystem used for detaching particles from a contaminated object and carrying the detached particles to a particle collection area, according to an embodiment of the present invention;

FIG. 3a illustrates a non-dimensionally scaled side view of the subsystem accommodating a shoe placed upon an inspected object grille, according to an embodiment of the present invention;

FIG. 3b illustrates a non-dimensionally scaled front view of the subsystem accommodating a shoe placed upon an inspected object grille, according to an embodiment of the present invention;

FIG. 3c illustrates a non-dimensionally scaled oblique view of the air curtain flow acting as one of the walls of the air stream chamber above the uppers and in front of the toes of inspected footwear;

FIG. 3d illustrates a non-dimensionally scaled oblique view of the air curtain flow acting as one of the walls of the air stream chamber behind the heels of inspected footwear;

FIG. 4a illustrates a non-dimensionally scaled front view of the subsystem accommodating a boot placed upon an inspected object grille, according to an embodiment of the present invention;

FIG. 4b illustrates a non-dimensionally scaled side view of the subsystem accommodating a boot placed upon an inspected object grille, according to an embodiment of the present invention;

FIG. 5 illustrates a non-dimensionally scaled perspective view of one configuration of a footwear inspection system operating with a person wearing the footwear, according to an embodiment of the present invention;

FIG. 6 illustrates a non-dimensionally scaled perspective view of a second configuration of a footwear inspection system operating with a person wearing the footwear, according to an embodiment of the present invention;

FIG. 7 illustrates a non-dimensionally scaled perspective view of a third configuration of a footwear inspection system operating with a person wearing the footwear, according to an embodiment of the present invention;

FIG. 8 illustrates a non-dimensionally scaled perspective view of a fourth configuration of a footwear inspection system operating with a person wearing the footwear, according to an embodiment of the present invention;

FIG. 9 illustrates a non-dimensionally scaled perspective view of a fifth configuration of a footwear inspection system operating with a person wearing the footwear, according to an embodiment of the present invention;

FIG. 10 illustrates a non-dimensionally scaled perspective view of one dual inspection units sharing a common compressor and controller configuration of a footwear inspection system operating with a person wearing the footwear, according to an embodiment of the present invention;

FIG. 11 illustrates a non-dimensionally scaled perspective view of another dual inspection units sharing a common compressor and controller configuration of a footwear inspection system operating with a person wearing the footwear, according to an embodiment of the present invention; and

FIG. 12 illustrates a flowchart of the inspection method according to an embodiment of the present invention;

### DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide an

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment or invention. Furthermore, the particular features, structures, or characteristics may be combined in any suitable manner in one or more embodiments.

The drawings set forth the preferred embodiments of the present invention. The embodiments of the invention disclosed herein are the best modes contemplated by the inventors for carrying out their invention in a commercial environment, although it should be understood that various modifications can be accomplished within the parameters of the present invention.

The term ‘contaminated object’ relates hereinafter in a non-limiting manner to an object having on the external surface adhered traces particles that do not belong to the object.

The term ‘detaching’ relates hereinafter in a non-limiting manner to the removal of particles that do not belong to an object yet adhering to it

The term ‘recognizing’ relates hereinafter in a non-limiting manner to identifying a material from knowledge of characteristics, by detecting a trace of its particles.

The term ‘object placement grille’ relates hereinafter in a non-limiting manner to a horizontal panel having an array of holes or is made of a series of crossed bars, used for placing the inspected object.

The term ‘air stream chamber’ refers to the immediate volume surrounding inspected footwear above the object placement grille. The walls of the air stream chamber include the grille as the largest part of the floor, solid side walls as part of the structure of the invention and air curtains which act as upper and front and back walls.

The term ‘air curtain’ refers to a flowing flat air surface such as is created by commercially available ‘air knives.’ Certain air knives make use of the Coanda effect described below.

The term ‘particle collection area’ relates hereinafter in a non-limiting manner to the target location where particles are accumulated.

The term ‘coanda effect’ relates hereinafter in a non-limiting manner to the tendency of a stream of fluid to stay attached to a convex surface, rather than follow a straight line in its original direction. Such a flow then has reduced pressure on the convex surface which is used to pull in surrounding air not associated with the original stream of fluid.

The system disclosed in the present invention detaches particles adhered to contaminated object's exterior surface and transports the detached particles onto a substantially small area which is cross sectional to the particle stream, where the kind of particle material is analyzed. The operation is carried out by an aerodynamic system accommodating blowing jets and an assisting air stream directed to a vacuum port. Particles are detached from the entire exterior surface of the object by several air blowing jets surrounding the contaminated object. The detached particles are moving with the air stream onto a surface area located behind of the vacuum port and are further detected and analyzed to recognize the material of the particles. The system is utilized to collect a substantial portion of particles adhering to a contaminated object exterior surface and none of the particles existing within the object. Thus system operation is carried out with the object placed on the system's grille being exposed to the atmospheric conditions existing at the specific location of the system. A commercial particle detector sub-system is used with the present invention most commonly for inspecting whether the inspected object had been in contact with some hazardous materials.

Different kinds of commercially available particle detectors are using various techniques for identifying sought for hazardous materials from traces of particles. A particle analyzer may be integrated with system of the present invention into a total inspection system configuration detecting and analyzing particles of sought for materials that have been removed from an object's exterior surface.

A total inspection system can be configured alternatively as a separate system of the present system accumulating particles onto a surface area of filter material and the contaminated filter material being removed from the system and automatically or manually disposed within a commercially available analyzer.

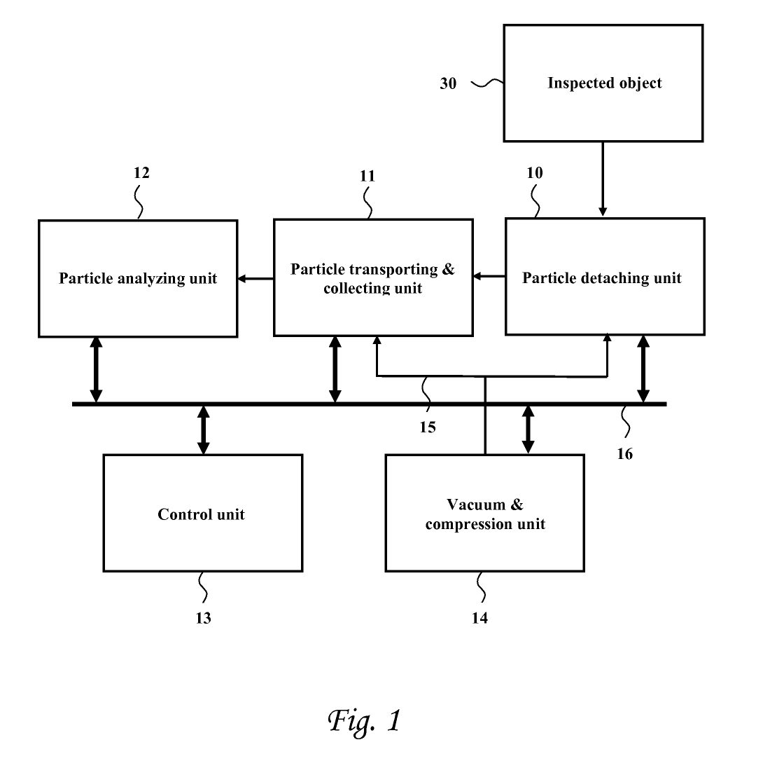

Reference is now made to FIG. 1, which is a schematic block diagram of a total inspection system. A particle-detaching unit 10 initially operates on an inspected object 30. Several blowing jets included in particle detaching unit 10, are surrounding inspected object 30 for utilizing airflow power, direction and distribution designed to maximize detaching particles adhering to the exterior surface of object 30. Particle transporting and collection unit 11 carries the particles detached from the exterior surface of the inspected object with the air stream to a particle detecting and analyzing unit 12 to recognize and determine whether particles of some sought for material were detected. The system further includes a vacuum and compression unit 14. The compression part of this unit operates the blowing jets and directs the air stream carrying the detached particles. The air stream is directed to vacuum part of unit 14 and onto the particle collection area. Vacuum and compression unit 14 is connected aerodynamically to particle detaching unit 10 and particle transporting and collecting unit 11 through connection lines 15. The system further includes a control unit 13 providing electrical power and control signals to all the system units via connection lines 16. The control unit includes also a user console and interfaces to external systems for accommodating a totally integrated inspection system.

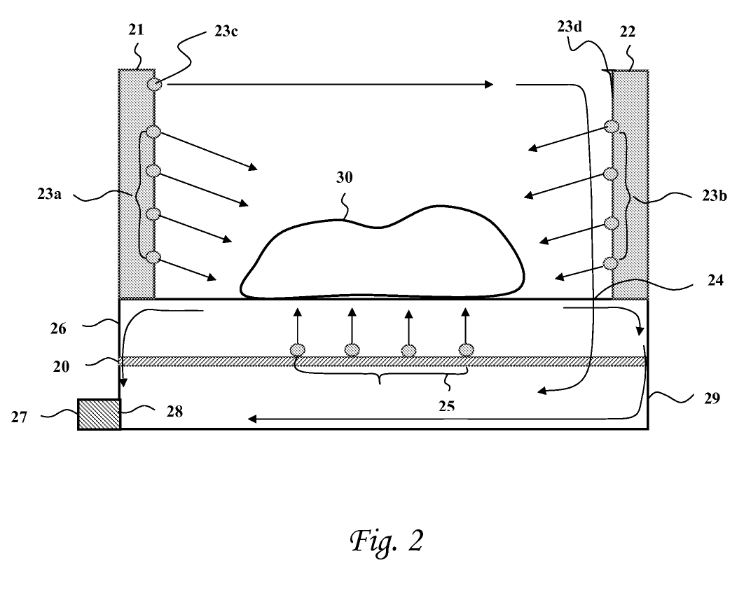

Reference is now made to FIG. 2 which is a cross sectional view of a fundamental configuration of the disclosed invention. Inspected object 30 is placed on the object inspection grille 24, surrounded by ambient air. The system operates with the object exposed to ambient conditions since only particles adhering to the exterior surface of object 30 need to be removed. Blowing jets 23a disposed on the inner partition of section 21, blowing jets 23b disposed on inner partition 22 and blowing jets 25 disposed on partition 20 are used to detach particles adhering to the exterior surface of object 30. Air jet 23c is an air curtain preventing particles from escaping the confines of the detaching unit. The air curtain is turned downward at the opposite wall by a series of turning vanes 23d. The extent of the air curtain is over the tops of the shoes as well as the front. A separate air curtain (not shown) operates behind the heels of the shoes to prevent particles from leaving the area backwards. The general blowing direction of the jets designed to accommodate removal of adhering particles for related object size and shape, are depicted by the direction of the arrows. The object placement grille 24, which is the top panel of chamber 26, includes a system for activating only those jets required for a specific footwear geometry. For example, the jets may be weight activated when placing the object of activated by a controller when a presence of an object is detected. Jet airflow blows upwardly onto the bottom exterior surface of the object and detached particles flow back downward into chamber 26. Consequently particles enter chamber 26 rather than adhering to the top chamber exterior partition. An air stream flowing through the openings of the top of chamber 26 is pushed to the top interior surface of chamber 26 and an air stream is flowing from the center leftward and rightward from the center in close proximity to the interior side of the top of chamber 26. For example, when this air stream hits the vertical partitions of chamber 26 fans using the coanda effect may be used to assist directing particles to the vacuum port. Coanda fans add ambient air to the air stream, thus greatly increasing volume flow and improving efficiency. The air stream is pulling the ambient air. This causes lower air pressure inside and around the air stream. The interaction of the air stream with the solid vertical partitions causes a drop of air pressure between the air stream and the surface. The curved bottom surface of chamber 29 causes a continuing acceleration of the air stream, and thus a continuing area of low pressure between the air stream and the bottom surface. Added air accelerates even further the air stream to the particle collecting area 28 located behind the vacuum port 27. The design principle used by the present invention increases airflow velocity near the floor, improves control of the airflow of the layers of air adjacent to the bottom of chamber 29 and thus maximizes the number of particles successfully reaching the particle collection area. Even more so the design principle reduces the required air volume by introducing an air multiplying effect.

Commercially available instruments utilizing a variety of techniques for detecting and analyzing traces of particles reaching the particle collection area are used for recognizing the materials of trace of particles. The analyzer instruments either accept filters manually or automatically. Alternatively, integrating the system of the present invention with an analyzer instrument configures a total object inspection system. The inspection procedure is substantially shorter when the system and the particle detector are configured as an integrated total system. Nevertheless, an inspection footwear procedure takes typically several seconds in any system configuration.

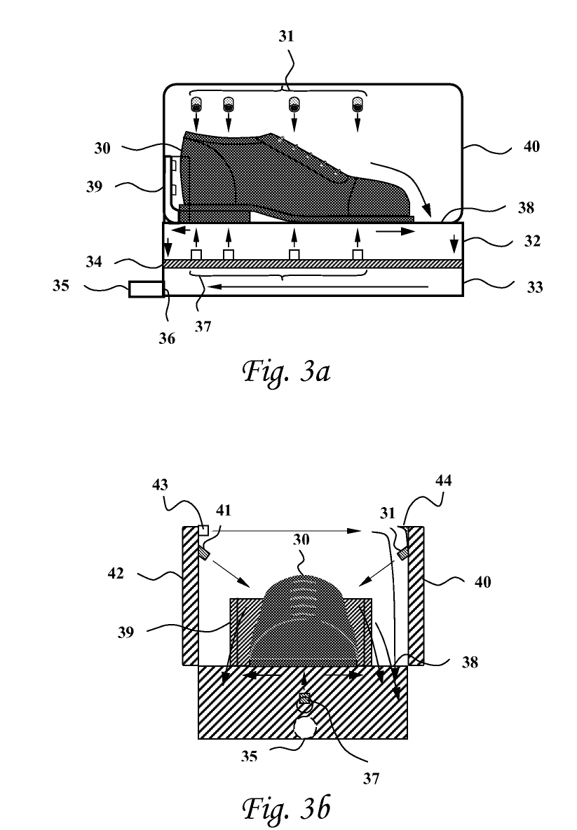

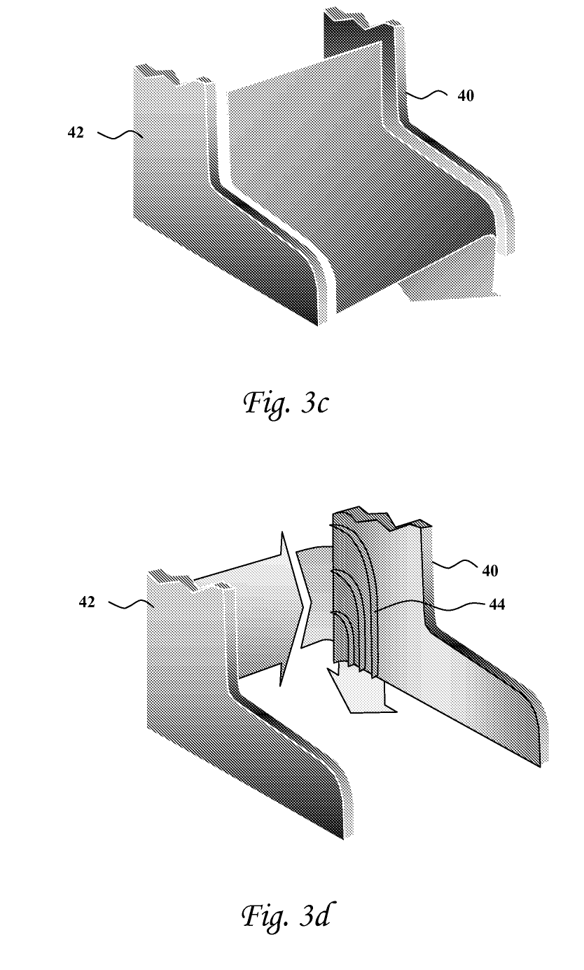

Reference is now made to FIG. 3a, a side view of a shoe 30 being an inspected object, placed onto a shoe placement grille 38 is the object inspected by the system. For graphical presentation reasons, shoe 30 is shown taken off from a person's foot, yet a person wearing the shoe is actually standing on the shoe placement grille 38 of the system. A plurality of blowing jets including jets 31 on one perpendicular section partition, blowing jets disposed on perpendicular partition 39 behind the shoe and blowing jets 37 disposed underneath the shoe placement grille, surrounding the shoe, are detaching particles from the entire shoe exterior surface. The bottom of the system includes chamber 32 and chamber 33 separated by partition 34. The object placement grille 38 includes an array of openings. There may also be a system for activating only those jets required for a specific footwear geometry, when the system is operating. Ambient air with the detached particles, flows through the openings in the grille 38 down into chamber 32 and continue flowing by creating an airflow in proximity the inner surface of grille 38. The particles are further directed, in the chamber 32, by specialized jets, toward the vacuum port. For example, Coanda-based jets may be used at various points on the chamber walls. Consequently, the overall air amplifying effect of the system is further increased and the fast flow of air stream prevents moving particles from sticking to the system surfaces so that a substantial portion of particles reach the collection area. The particles reaching the collection area are detected and analyzed by an instrument analyzer.

Reference is now made to FIG. 3b, a front view of the system depicting additional parts of the system not shown in the side view. The additional parts include perpendicular partition 42 with jets 41 mounted on it. The remainder parts identified by the same numbers are shown and explained in the preceding figure. Note that item 43 again represents the air curtain that prevents particles from leaving anywhere except through the grille.

Reference is now made to FIG. 3c showing a detail of how the air curtain covers the area above the inspected shoe uppers and in so doing acts as a barrier to particles to keep them from escaping. Note as well that the air curtain flow is turned downward to enter the lower chamber 38 so that any particles entrained by the air curtain will be available for being collected.

Reference is now made to FIG. 3d showing a detail of the air curtain in the heel area of inspected footwear. The air curtain flow is also turned downward by a series of turning vanes 44. Similar vanes also turn the air curtain flow in FIG. 3c.

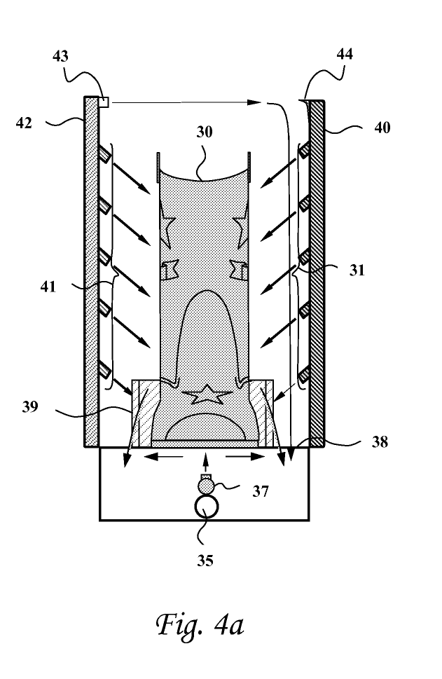

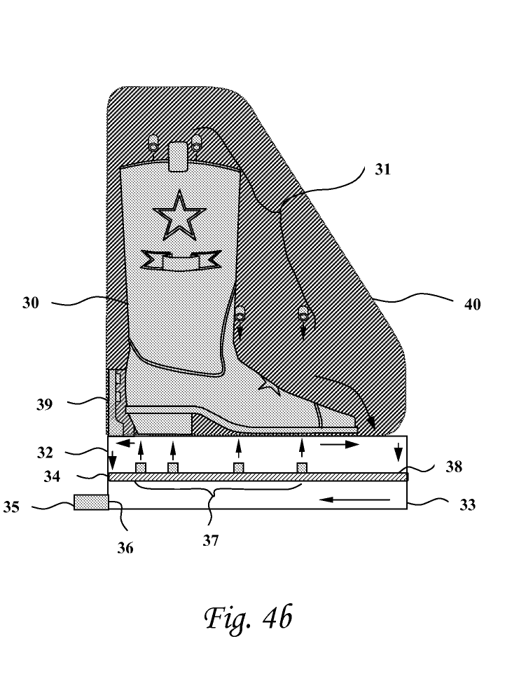

Reference is now made to FIG. 4a, a back view of the system accommodating a boot as an inspected object. As in the event of shoe inspection, the boot is not taken off from the foot of the person wearing it. The person rather steps on a dedicated area of the machine floor. The system is principally identical to the system used for shoe inspection, excluding the height of perpendicular partitions 40 and 42 and the arrangement of blowing jets 31, 41, 43 and 39. The arrangement of blowing jets 37 are identical to the system for shoes since those jets are detaching particles of the sole of a boot which is very similar to a sole of as shoe. As with the preceding system boot stepping panel 38 has an array of openings covered by valves and vacuum port 35 is at the same location. The principle of operation of the boot inspection system is identical to that of the shoe inspection system described in the preceding section. Preferably the system is designed to accommodate inspecting a whole range of footwear sizes by operating the various blowing jets in a controllable manner.

Reference is now made to FIG. 4.4b, a side view of the system depicting in greater detail blowing jets 31 and 37. The bottom part of the system, which includes chamber 38 and chamber 33 separated by partition 34, accommodates the air streams carrying the particles to the collection area in an identical manner to the shoe inspection system.

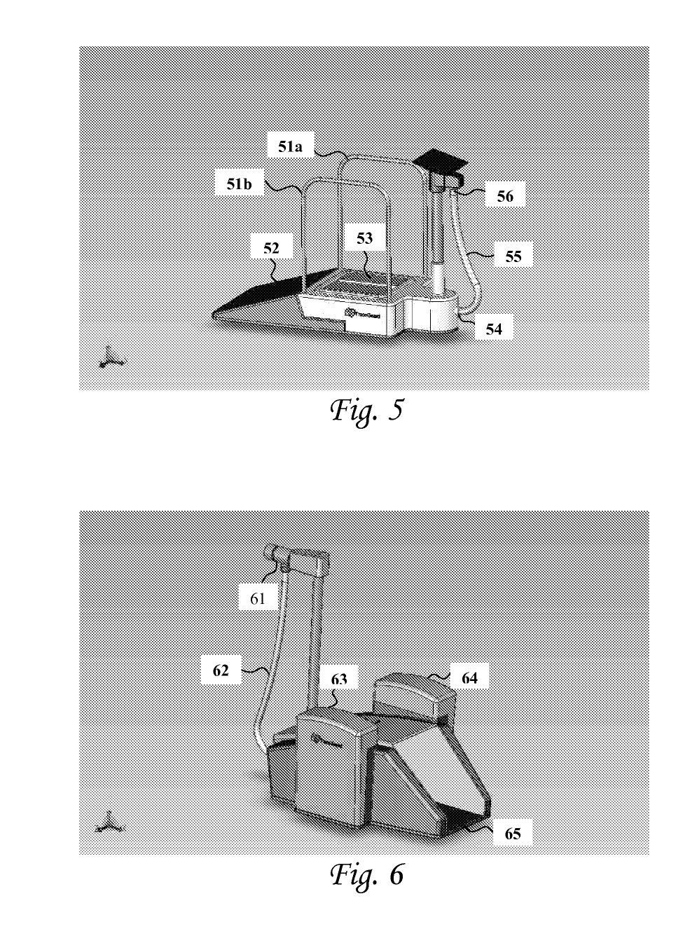

Reference is now made to FIG. 5, a non-scaled dimensionally perspective view of a first configuration of the footwear inspection system. A ramp 52 is used for the convenience of the person using the system to climb effortlessly to the object placement grille 53. Object placement grille 53 is recessed to assist in keeping particles within the system. Hand rails 51a and 51b assists the person being on the system in maintaining balance and comfort. The air stream at the bottom chamber of the system carries the particles through vacuum port 54 and hose 55 to the collection area 56. The jets compressor and vacuum portions, as well as the controller, are configured within each individual inspection system.

Reference is now made to FIG. 6 a non-scaled dimensionally perspective view of a second configuration of the footwear inspection system. The area surrounding the inspected footwear is substantially enclosed in this configuration. This assists in preventing particles from exiting the inspection system. The low position of the object placement grille 65 makes it easy for a person to get on the inspection system. Perpendicular chamber 63 and perpendicular chamber 64 are substantially wide to provide room for the compression and vacuum units of the system. The air stream carrying the particles, reach the collection area 61, via hose 62.

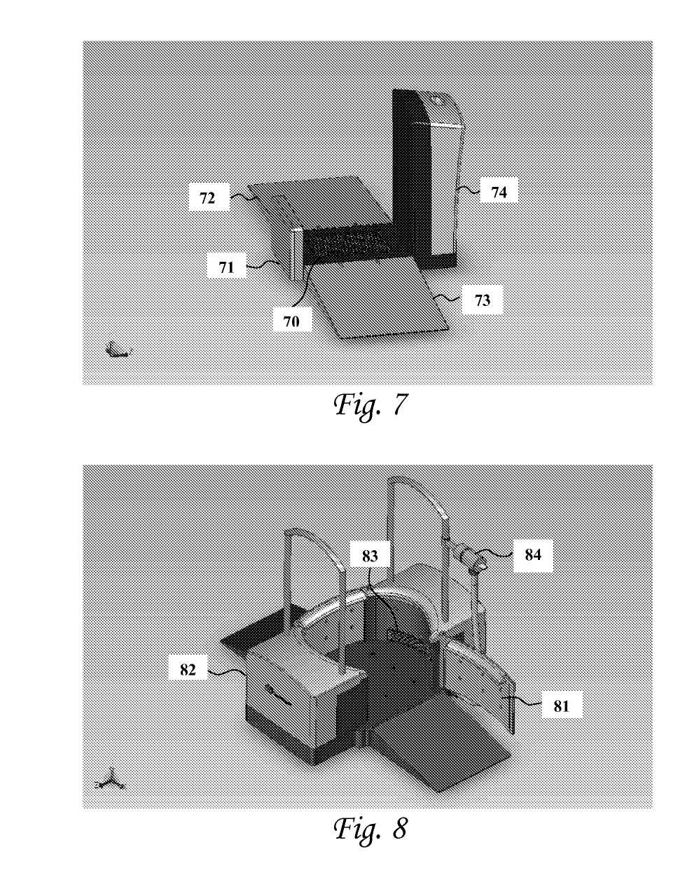

Reference is now made to FIG. 7 a non-scaled dimensionally perspective view of a third configuration of a footwear placement system. The system is structured symmetrically with respect to front and back and asymmetrically with respect with respect to the side perpendicular partitions. Ramp 73 and ramp 72 are used for a person getting on the system and leaving the system at the end of an inspection procedure. Blowing jets are displaced on the object placement grill located on the bottom as well as on the inner partition of vertical section 71 and inner partition of vertical section 74. Vertical section 74 is sized substantially larger than vertical section 71 for housing the majority of system assemblies.

Reference is now made to FIG. 8 a non-scaled dimensionally perspective view of a fourth configuration of a footwear inspection system. A front door 81 and a back door located symmetrically on the front and the back of system are enclosing a person during inspection. Blowing jets displaced on the interior partitions of front and back doors, on the bottom, on left vertical section 82 and similarly shaped right vertical section are surrounding a standing person's footwear. The stream of air carrying the detached particles, is directed towards vacuum port 83 and out through a hose to collection area 84. Vacuum, pressure and control units are placed within the vertical sections of the system.

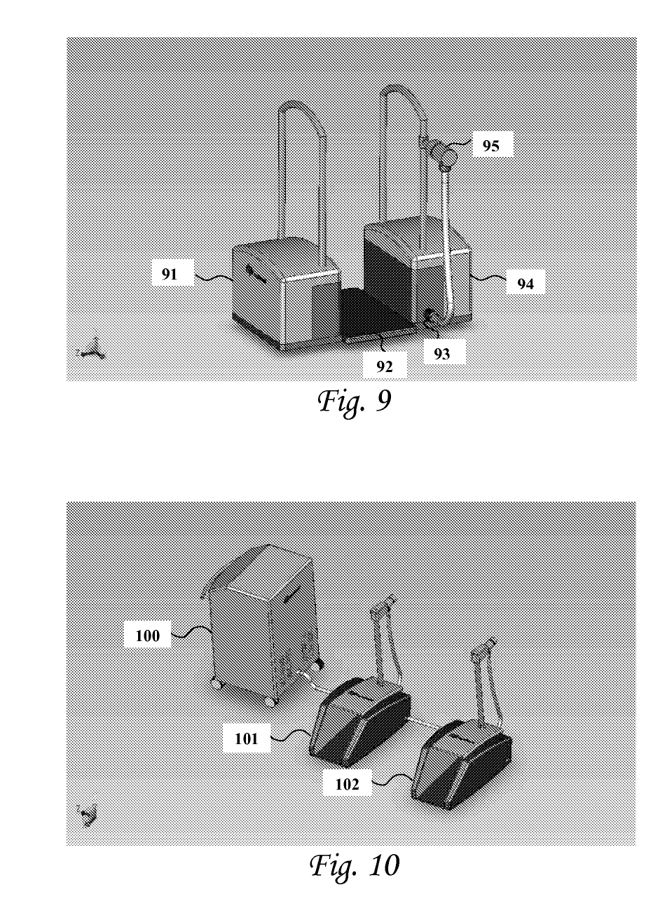

Reference is now made to FIG. 9 a non-scaled dimensionally perspective view of a fifth configuration of a footwear inspection system. Blowing jets are disposed on partitions facing the inspection area of vertical section 91, horizontal section 92 and vertical section 94. Air stream gets out of vacuum port 93 located in vertical section 94 and particles carried by the air stream are transported to collection area 95. The system placement grille is substantially close to the floor for easy use by an inspected person. A substantial portion of system units is includes in the wide vertical section 91 and wide vertical section 95.

Each of the above foot inspection systems is equipped also with stoppable casters for effortless moving when it is required.

Reference is now made to FIG. 10 a non-scaled dimensionally perspective view of a sixth configuration of a footwear inspection system. In this system, vacuum, pressure and control units are housed as in a single console 100 serving of inspection console 101 and inspection station 102. Different designs can accommodate a greater number of inspection stations served by a single console. The inspection stations in this kind of configuration have a substantially smaller physical size and properly designed the system can occupy smaller scarcely limited floor space.

As a matter of design practicality, various cases have to be taken into account for a system design that accommodates all possibilities. The various cases include in a non-limiting manner: high heel footwear, women wearing skirts, footwear with loose appendages or decorations and people with ambulatory problems.

Another matter of design practicality is related to weather conditions i.e., high air humidity which may require cooling the system for condensation of water molecules.

Another matter of practicality is related to dirt adhering to people's footwear. This requires accommodating separation between particles of interest and dirt in the system. This separation is utilized by any of the following techniques in a non-limited manner: Filtering, centrifugal segregation, electrostatic precipitation, vibration and scrubbing.

Particle detection and analysis is carried out by commercially available instruments utilizing one of several techniques used for detection and analysis of traces of particles in a non limiting manner: Ion Mobility Spectroscopy (IMS), gas chromatography and laser induce spectroscopy. The detector analyzer is usable in a separate configuration whereas filters from the collection area of the system are transferred manually or automatically to the analyzer. Alternatively, an analyzer is integrated with the system by way that collection area is within the analyzer.

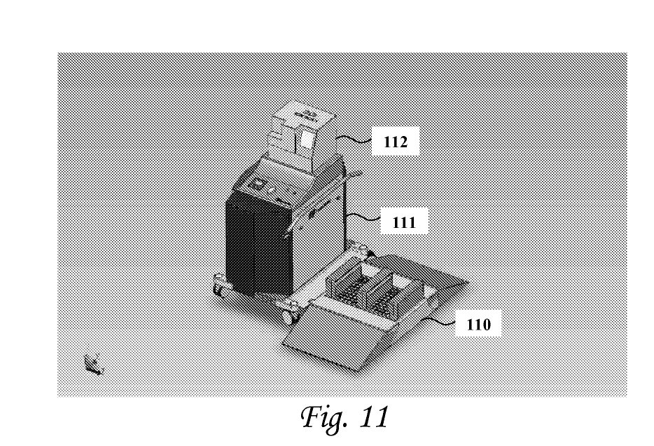

Reference is now made to FIG. 11 a non-scaled dimensionally perspective view of a seventh configuration of a footwear inspection system. This system is configured similarly to the system configuration in the preceding section, i.e. a single console serves a plurality of inspection station. Dual inspection station 110 is served by compression console 111 and control console 112 placed on top. The number of individual inspection assemblies included in a station can be increased in a non- limiting manner to any reasonably practical number.

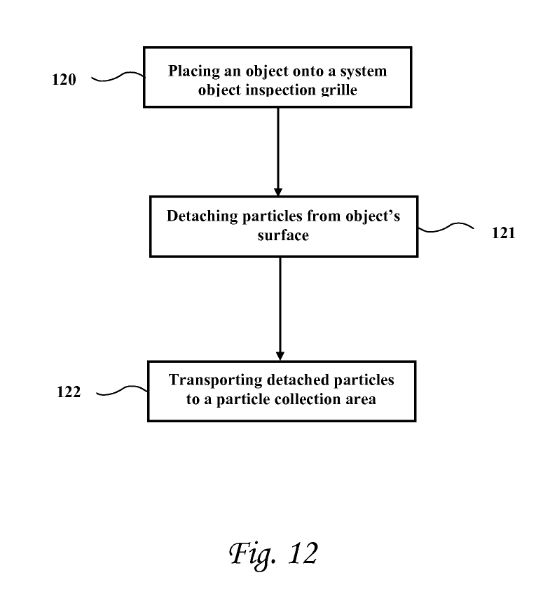

Reference is now made to FIG. 12, a flow chart of the method used by the system of the present invention. The process begins with placing the inspected object on the object placement grille in step 110. Particles adhering to the exterior surfaces of the objects are detached from the object surface in step 111 by jets blowing in all directions on the exterior surface, thus exerting force on the adhering particles. The particles detached from the exterior surface are directed by the air stream in step 112 to the vacuum port and further to the collection area.

The embodiments of the disclosed invention can be varied in many ways and still be considered manifestations of the disclosed invention.

A first variation of the invention is related to the number and the arrangements of the blowing jets. Accommodating mechanical scanning jets whereas each scanning jet ‘covers’ a wide range of jet blowing angles can reduce the number of blowing jets or selectively activating jets in a controllable manner. Shaking may be used additional to blowing jets for detaching adhering particles.

A second variation is related to the filters located at the collection area of the system in the event that the analyzer is separate from the system. By configuring the filters in a batch including several individual filters, a substantial time saving is introduced. This is attributable to the fact that in the event that a batch of filters is used, the inspection system and the analyzer are loaded with filters once per several filters and not per each individual filter and position of an individual filter changes automatically after each inspection procedure.

It will be appreciated that the described methods may be varied in many ways including, changing the order of steps, and/or performing a plurality of steps concurrently. It should also be appreciated that the above described description of methods and apparatus are to be interpreted as including apparatus for carrying out the methods, and methods of using the apparatus, and computer software for implementing the various automated control methods on a general purpose or specialized computer system, of any type as well known to a person or ordinary skill, and which need not be described in detail herein for enabling a person of ordinary skill to practice the invention, since such a person is well versed in industrial and control computers, their programming, and integration into an operating system.

The system of the present invention is commonly used along with a particle detector for inspecting passenger footwear in airports with the passengers stepping on and standing on a dedicated panel of the system and without the inconvenience associated with taking off footwear for this inspection.

For the main embodiments of the invention, the particular selection of type and model is not critical, though where specifically identified, this may be relevant. The present invention has been described using detailed descriptions of embodiments thereof that are provided by way of example and are not intended to limit the scope of the invention. No limitation, in general, or by way of words such as “may”, “should”, “preferably”, “must”, or other term denoting a degree of importance or motivation, should be considered as a limitation on the scope of the claims or their equivalents unless expressly present in such claim as a literal limitation on its scope. It should be understood that features and steps described with respect to one embodiment may be used with other embodiments and that not all embodiments of the invention have all of the features and/or steps shown in a particular figure or described with respect to one of the embodiments. That is, the disclosure should be considered complete from combinatorial point of view, with each embodiment of each element considered disclosed in conjunction with each other embodiment of each element (and indeed in various combinations of compatible implementations of variations in the same element). Variations of embodiments described will occur to persons of the art. Furthermore, the terms “comprise,” “include,” “have” and their conjugates, shall mean, when used in the claims, “including but not necessarily limited to.” Each element present in the claims in the singular shall mean one or more element as claimed, and when an option is provided for one or more of a group, it shall be interpreted to mean that the claim requires only one member selected from the various options, and shall not require one of each option. The abstract shall not be interpreted as limiting on the scope of the application or claims.

It is noted that some of the above described embodiments may describe the best mode contemplated by the inventors and therefore may include structure, acts or details of structures and acts that may not be essential to the invention and which are described as examples. Structure and acts described herein are replaceable by equivalents performing the same function, even if the structure or acts are different, as known in the art. Therefore, the scope of the invention is limited only by the elements and limitations as used in the claims.

1. A system for detaching particles which adhere to the exterior surface of an object, and carrying said particles to a particle collection area, comprising:
(i) an object placement grille;
(ii) an air stream chamber; where said grille is one of the partitions of said chamber;
(iii) a plurality of blowing jets; said jets are surrounding said object; some of which provide air curtains which are also partitions of said chamber, and
(iv) a vacuum port;
wherein while said object is being under normal atmospheric conditions, said particles are being detached from said object exterior surface by said plurality of blowing jets;
said detached particles are passing through said grille and are carried by near surface airstreams generated within said chamber and directed towards said vacuum port.

2. The system according to claim 1, wherein a set of special jets direct said particles to the vacuum port, said particles do not stick to said inside chamber surfaces and consequently a substantial portion said particles reach said particle collection area. Other special jets provide an air curtain as part of the walls of the air stream chamber.

3. The system according to claim 1, wherein a particle analyzer analyzes said particles reaching said collection area.

4. The system according to claim 1, further comprises a vacuum and compression units.

5. The system according to claim 1, further comprised a control system controlling various system assemblies.

6. The system according to claim 5, wherein said control system further comprises an application programming interface and an interface to external systems.

7. A system for inspecting footwear while worn, comprising:
(i) a grille on which the worn footwear is placed;
(ii) an air stream chamber; wherein said grille is one of the partitions of said chamber;
(iii) a plurality of blowing jets; said jets are surrounding said object; some of which provide air curtains which are also partitions of said chamber, and
(iv) a vacuum port;
wherein while said object is being under normal atmospheric conditions, said particles are being detached from said object exterior surface by said plurality of blowing jets;
said detached particles are passing through said grille holes and are carried by near surface airstreams generated within said chamber and directed towards said vacuum port.

8. The system according to claim 7, wherein a particle analyzer analyzes said particles reaching said collection area.

9. The system according to claim 8, wherein said analyzer is an instrument selected from a list consisting of: Ion Mobility Spectroscopy (IMS), gas chromatography, laser induced spectroscopy or any combination there of

10. The system according to claim 7, further comprising a vacuum and compression unit.

11. The system according to claim 7, wherein a single vacuum and compression unit is serving a plurality of footwear inspection stations.

12. The system according to claim 7, wherein said system is adapted for effortlessly getting on the system and getting off the system.

13. The system according to claim 7, wherein said collected particles reaching said particle collection area are adhering to a filter disposed at said particle collection area.

14. The system according to claim 13, wherein a batch of a plurality of filters is configured and an individual filter of the batch is selected each time automatically.

15. The system according to claim 7, comprises accommodating high humidity atmospheric conditions.

16. The system according to claim 7, adaptable to separating dirt form said particles prior detecting and analyzing said particles.

17. The system according to claim 7, adaptable to any size and shape of footwear.

18. A method for detaching particles adhering to the exterior surface of an object, comprising:
(i) a system comprising: an object placement grille,
an air stream chamber, whereas said grille is one of the partitions of said chamber, a plurality of blowing jets, said jets are surrounding said object and a vacuum port some of which provide air curtains which are also partitions of said chamber;
(ii) placing an object onto said system object placement grille; and
(iii) detaching said particles from said object surface
wherein while said object is being under normal atmospheric conditions, detaching said particles from said object exterior surface is carried out by said plurality of blowing jets some of said jets also providing an air curtain acting as some of the walls of the air stream chamber and passing said detached particles through said grille and are carried by near surface airstreams generated within said chamber and directed towards said vacuum port.

19. The method according to claim 18, further comprising detecting and analyzing said particles by a particle analyzer.
